(19) United States
(12) Patent Application Publication
(10) Pub. No.: US 2009/0151536 A1
(43) Pub. Date: Jun. 18, 2009

(54) CUTTER BLADE APPARATUS AND METHOD FOR CUTTING RECEIPT PAPER

(75) Inventor: Stacy L. Arrington, Raleigh, NC (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/954,446

(22) Filed: Dec. 12, 2007

(51) Int. Cl. B26D 1/02; B26D 1/00

(52) U.S. Cl. 83/856; 83/13

(57) ABSTRACT

The cutter blade apparatus includes a blade mount including a first attachment portion and second attachment portion, the first attachment portion and second attachment portion being disposed at substantially opposite ends of the mount, wherein the first attachment portion and second attachment portion are configured to releasably associate the mount with notches disposed at opposite sides of a printer housing of the printer, and a blade in fixed association with the mount, the blade including a first cutting edge and a second cutting edge, wherein the mount is configurable between a first blade position and a second blade position when the mount is released from association with the printer housing, the first blade position disposing the first cutting edge in cutting proximity to paper disposed in the printer, and the second blade position disposing the second cutting edge in cutting proximity to the paper disposed in the printer.

### BACKGROUND OF THE INVENTION

1. Field of the Invention

The invention relates generally to a cutter blade apparatus, and more particularly to a cutter blade apparatus for cutting receipt paper.

2. Description of the Background

Thermal receipt printers generally feature an automatic paper cutting mechanism. Typically, this mechanism consists of one blade rigidly mounted in the printer and a second blade that moves to perform the cut action. These blades need to reliably cut the paper from 1-2 million times. Sometimes customers use a low quality paper that can excessively wear the cutter blades before their projected life. The blades then have to be replaced. Replacing the stationary blade can be difficult, as it is usually attached to the printer housing for stability.

### SUMMARY OF THE INVENTION

Disclosed is a cutter blade apparatus for a receipt printer, the apparatus including a blade mount including a first attachment portion and second attachment portion, the first attachment portion and second attachment portion being disposed at substantially opposite ends of the blade mount, wherein the first attachment portion and second attachment portion are configured to releasably associate the blade mount with mount notches disposed at opposite sides of a receipt printer housing of the receipt printer, and a blade in fixed association with the blade mount, the blade including a first cutting edge and a second cutting edge, wherein the blade mount is configurable between a first blade position and a second blade position when the blade mount is released from association with the receipt printer housing, the first blade position disposing the first cutting edge in cutting proximity to paper disposed in the receipt printer, and the second blade position disposing the second cutting edge in cutting proximity to the paper disposed in the receipt printer.

Also disclosed is a method for cutting receipt paper, the method including providing a blade mount including a first attachment portion and second attachment portion, the first attachment portion and second attachment portion being disposed at substantially opposite ends of the blade mount, wherein the first attachment portion and second attachment portion are configured to releasably associate the blade mount with mount notches disposed at opposite sides of a receipt printer housing of the receipt printer, providing a blade in fixed association with the blade mount, the blade including a first cutting edge and a second cutting edge, wherein the blade mount is configurable between a first blade position and a second blade position when the blade mount is released from association with the receipt printer housing, the first blade position disposing the first cutting edge in cutting proximity to paper disposed in the receipt printer, and the second blade position disposing the second cutting edge in cutting proximity to the paper disposed in the receipt printer, cutting the paper with the first cutting edge during usage of the printer, performing the cutting until the first cutting edge has exceeded a useful life of the first cutting edge, rotating the blade mount into the second blade position, and cutting the paper with the second cutting edge during usage of the printer.

### BRIEF DESCRIPTION OF THE FIGURES

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view of a cutter blade apparatus, a blade mount of the apparatus being disposed in a first blade position;

FIG. 2 is a perspective view of the cutter blade apparatus, the blade mount of the apparatus being disposed in a second blade position; and

FIG. 3 is an elevated view of the blade mount and blade.

### DETAILED DESCRIPTION OF THE INVENTION

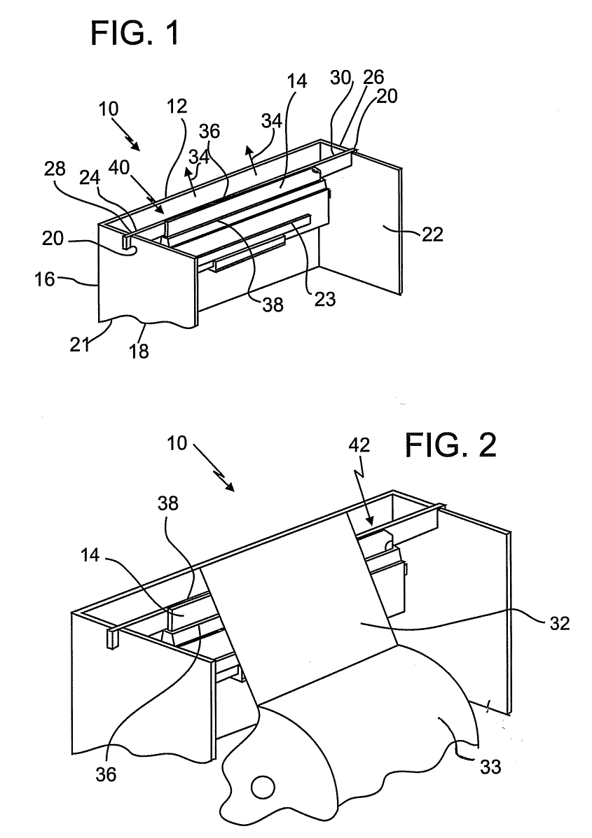

Referring to FIGS. 1 and 2, a cutter blade apparatus 10 is illustrated. The apparatus 10 includes a blade mount 12 and blade 14, which are disposed in a receipt printer housing 16 of a receipt printer 18 (both partially shown in the Figures). The receipt printer housing 16 includes mount notches 20 disposed at opposite sides 21 and 22 of the printer housing 16. These notches 20 are configured to releasably associate the blade mount 12, and therefore the blade 14, with the printer housing 16. The printer 18 also includes a thermal print head 23, which is disposed in proximity to the blade 14.

As shown in FIGS. 1 and 2, the blade mount 12 includes a first attachment portion 24 and second attachment portion 26. These portions 24 and 26 are disposed at respective, substantially opposite ends 28 and 30 of the blade mount 12. The portions 24 and 26 are further shaped and configured for disposal within the notches 20 of the printer housing 16. Disposal of the attachment portions 24 and 26 in the notches 20 associates the mount 12 and blade 14 with the printer 18 such that the blade 14 may cut receipt paper 32 (supplied by a paper roll 33, as shown in FIG. 2) during printer operation. The mount 12 is removable from association with the printer housing 16 via a relatively upward movement 34 of the mount 12. This movement 34 easily removes the attachment portions 24 and 26 from the notches 20, allowing the releasable mount association mentioned above.

As is also shown in FIGS. 1 and 2, the blade 14 is fixedly associated with the mount 12. This association may be accomplished via any mechanical attachment or adhesive that will securely hold the blade 14 in non-moveable contact with the mount 12. The blade 14 includes a first cutting edge 36 and a second cutting edge 38, which are both configured for cutting receipt paper 32 during normal operation of the receipt printer 18.

Referring now to FIG. 1 alone, the mount 12 is illustrated in a first blade position 40. When the mount 12 is in this position 40, the first cutting edge 36 is disposed in cutting proximity to the paper 32. This proximity allows the first cutting edge 36 to cut the paper 32 during operation of the printer 18. The first cutting edge 36 may perform the task of cutting the paper 32 until the edge 36 dulls, thus exceeding a useful cutting life of the edge 36.

Upon dulling of the first cutting edge 36, the mount 12 may be released and removed from association with the printer housing 16, and rotated 180 degrees. This rotation, and subsequent disposal of the attachment portions 24 and 26 back into the notches 20 (i.e. re-association of the rotated mount 12 with the printer housing 16), places the mount 12 in a second blade position 42. This second blade position 42 is illustrated in FIG. 2. When the mount 12 is in the second position 42, the second cutting edge 38 is disposed in cutting proximity to the paper 32. Similarly to the first edge 36, this proximity allows the second cutting edge 38 to cut the paper 32 during operation of the printer 18. By removing the mount 12 from the printer housing 16, configuring the mount into the second position 42, and placing the second edge 38 in cutting proximity to the paper 32, use of the blade 14 may continue even though the first edge 36 has dulled to a point of inefficiency. Thus, a useful life of the blade 14 is essentially doubled by the presence of the second edge 38 and configurability of the mount 12 between the first and second positions 40 and 42.

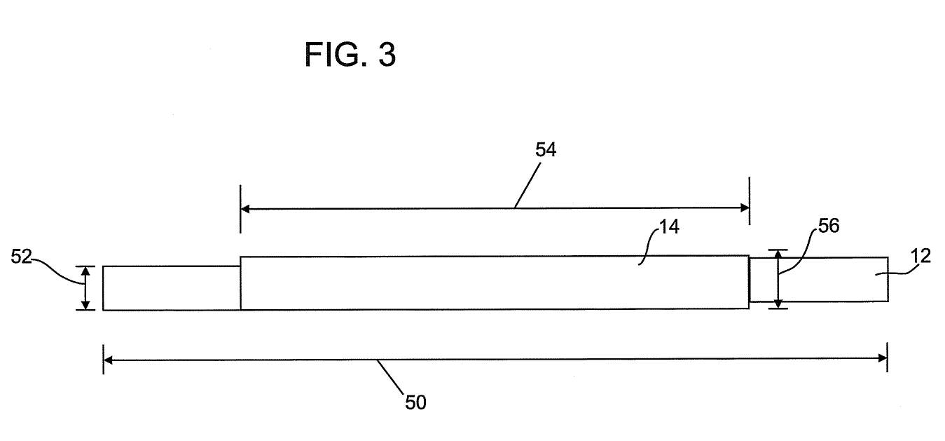

As is shown in FIG. 3, it should be appreciated that the mount 12 includes a mount length 50 that is greater than a mount height 52, and the blade 14 includes a blade length 54 that is greater than a blade height 56, wherein the mount length 50 is greater than the blade length 54 and the blade height 56 is greater than the mount height 52. These dimensions allow the attachment portions 24 and 26 of the mount 12 to extend beyond lateral ends of the blade 14, and further allow the cutting edges 36 and 38 of the blade 14 to extend beyond a relative top and bottom of the mount 12.

It should also be appreciated that the mount 12 and blade 14 are configured to remain stationary relative to the printer housing 16 during cutting of the paper 32. Lastly, it should be appreciated that the mount 12 and blade 14 may both be of metallic composition.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. Cutter blade apparatus for a receipt printer, the apparatus comprising:
a blade mount including a first attachment portion and second attachment portion, said first attachment portion and said second attachment portion being disposed at substantially opposite ends of said blade mount, wherein said first attachment portion and said second attachment portion are configured to releasably associate said blade mount with mount notches disposed at opposite sides of a receipt printer housing of the receipt printer; and
a blade in fixed association with said blade mount, said blade including a first cutting edge and a second cutting edge,
wherein said blade mount is configurable between a first blade position and a second blade position when said blade mount is released from association with said receipt printer housing, said first blade position disposing said first cutting edge in cutting proximity to paper disposed in the receipt printer, and said second blade position disposing said second cutting edge in cutting proximity to said paper disposed in the receipt printer.

2. The apparatus of claim 1, wherein said blade mount is metal.

3. The apparatus of claim 1, wherein said blade mount includes a mount length that is greater than a mount height and said blade includes a blade length that is greater than a blade height, wherein said mount length is greater than said blade length and said blade height is greater than said mount height.

4. The apparatus of claim 1, wherein a thermal print head is disposed in proximity to said blade.

5. The apparatus of claim 1, wherein said blade mount and said blade are configured to remain stationary relative to said printer housing during cutting of said paper.

6. A method for cutting receipt paper, the method comprising:
providing a blade mount including a first attachment portion and second attachment portion, said first attachment portion and said second attachment portion being disposed at substantially opposite ends of said blade mount, wherein said first attachment portion and said second attachment portion are configured to releasably associate said blade mount with mount notches disposed at opposite sides of a receipt printer housing of the receipt printer;
providing a blade in fixed association with said blade mount, said blade including a first cutting edge and a second cutting edge,
wherein said blade mount is configurable between a first blade position and a second blade position when said blade mount is released from association with said receipt printer housing, said first blade position disposing said first cutting edge in cutting proximity to paper disposed in the receipt printer, and said second blade position disposing said second cutting edge in cutting proximity to said paper disposed in the receipt printer;
cutting said paper with said first cutting edge during usage of the printer;
performing said cutting until said first cutting edge has exceeded a useful life of said first cutting edge;
rotating said blade mount into said second blade position; and
cutting said paper with said second cutting edge during usage of the printer.
